(19) United States
(12) Patent Application Publication
(10) Pub. No.: US 2026/0246703 A1
(43) Pub. Date: Aug. 20, 2026

(54) METHOD AND SYSTEM FOR NETWORK ANOMALY DETECTION BASED ON ENRICHED GRAPH REPRESENTATIONS

(71) Applicant: Verizon Patent and Licensing Inc., Basking Ridge, NJ (US)

(72) Inventors: Shashank Kartha, Bangalore (IN); Srinivasarao Valluru, Hyderabad (IN); Dhanraj J Nair, Flower Mound, TX (US)

(73) Assignee: Verizon Patent and Licensing Inc., Basking Ridge, NJ (US)

(21) Appl. No.: 19/057,011

(22) Filed: Feb. 19, 2025

(51) Int. Cl. H04L 41/12; H04L 41/06; H04L 41/16; H04L 41/22

(52) U.S. Cl. CPC H04L 41/12; H04L 41/06; H04L 41/16; H04L 41/22

(57) ABSTRACT

The present teaching relates to graph-based anomaly detection. Network stream data is used to build graphs representing the operation of the network with attributed nodes and edges representing network entities and relations thereof. The graphs are enriched at node, edge, and subgraph levels with node/edge anomaly scores, subgraph anomaly scores, missing edges, and embeddings and explanations thereof. Network anomalies are detected based on the enriched graphs in accordance with an anomaly detection model.

### BACKGROUND

Customers today expect telecommunication networks that are seamless, secure and reliable. However, network anomalies and fraudulent activities still impact customers, which may lead to unsatisfactory user experiences, loss of trust in the network, and potentially reduction of business revenue. Network anomalies often precede fraud or security breaches so that early detection facilitates effective prevention of such problems. In some situations, seemingly isolated anomalies may represent coordinated fraudulent acts that may reveal a security threat at a larger scale. Given that, earlier detection of network anomalies and prompt recognition of potential connections among them are critically important to deployment of appropriate actions to prevent network anomalies and/or remove any security threat in a shortest time.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for detecting anomalies of a network based on enriched graph representation of the network, in accordance with an embodiment of the present teaching;

FIG. 1B illustrates exemplary types of enriched graphs generated for facilitating network anomaly detection, in accordance with an embodiment of the present teaching;

FIG. 1C is a flowchart of an exemplary framework for detecting anomalies of a network based on enriched graph representation of the network, in accordance with an embodiment of the present teaching;

FIG. 2A depicts an exemplary system diagram of an enriched graph generator, in accordance with an embodiment of the present teaching;

FIG. 2B is a flowchart of an exemplary system diagram of an enriched graph generator, in accordance with an embodiment of the present teaching;

FIG. 3A illustrates an exemplary subgraph representing a network operation, in accordance with an embodiment of the present teaching;

FIG. 3B illustrates an exemplary subgraph with an anomaly detected from real-time stream data of a network, in accordance with an embodiment of the present teaching;

FIG. 3C illustrates another exemplary subgraph with a different anomaly detected from real-time stream data of a network, in accordance with an embodiment of the present teaching;

FIG. 3D shows an example where isolated anomalies, when connected, reveal a security threat to a network, in accordance with an embodiment of the present teaching;

FIG. 4 shows an exemplary implementation of an enriched graph generator using graph neural networks for generating different enriched graph representations, in accordance with an embodiment of the present teaching;

FIG. 5A depicts an exemplary system diagram of an anomaly evaluator, in accordance with an embodiment of the present teaching;

FIG. 5B is a flowchart of an exemplary process of an anomaly evaluator, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Smooth network operation is crucial for businesses today, particularly for high stakes applications in various domains. Early detection of fraud or anomaly are critically important in order to mitigate risks. Traditional solutions struggle to reliably identify anomalies, especially those anomalies that mimic regular user behavior. Some traditional anomaly detection systems rely on tabular data or rule-based methods to identify anomalies. Unfortunately, such approaches generally cannot capture complex relationships and hidden patterns in hyper-connected environments and consequentially encounter high false negatives, leaving subtle anomalies or complex anomalies undetected. For example, traditional approaches rely and assume individual and independent data points and learn from their characteristics, let alone revealing intricate relations among different data points, leading to ineffective detection and unmitigated risks.

Some existing solutions for anomaly detection may utilize supervised learning or simple graph analysis tools. Such solutions do not provide much improved results, either. For example, supervised learning models usually require extensive labeled training data, which is not only scarcely available but also expensive to obtain in the real-world. Although some existing solutions use graph-based approaches, they lack scalability as their implementations are computationally expensive and are inefficient when dealing with large scale real-time systems. Although such graph-based approaches may represent an improvement on detection, they cannot be used as a basis to articulate the reasoning associated with an anomaly so that detection of anomaly alone does not provide much guidance in terms of how to address the problem. That is, even when anomalies can be detected, it is difficult, if not impossible, to provide an adequate explanation for causation, making it hard to prevent similar problems in the future. Furthermore, anomaly patterns often change over time when fraudulent actors continually adopt new ways to breach the network. It is difficult for traditional solutions to dynamically adapt to the newly emerging anomaly patterns because of their static representations (e.g., tabular data, rules, or graphs) of anomalies.

The present invention aims to address these issues with a graph-based, adaptive, and scalable solution that captures not only the stable topological structure of a network but also the dynamic aspects of the network, including anomaly scoring over time on network nodes and connections and revealing the hidden implicit relationships among sub-networks through enriched graph representations. The graphs for the network are enriched with attributes/embeddings at different levels of detail, from nodes, edges, subgraphs, to hyper-connected subgraphs, to capture structural, contextual, hyper-connectivity so that together they provide actionable insights via explainable anomaly detection. The present teaching also leverages both historical and newly emerging anomaly patterns in real-time detection and facilitates prioritization of more critical anomalies with respect to limited resource. These characteristics of the present invention facilitate an anomaly detection scheme according to the invention that enables proactive mitigation of the risks/threats to the network.

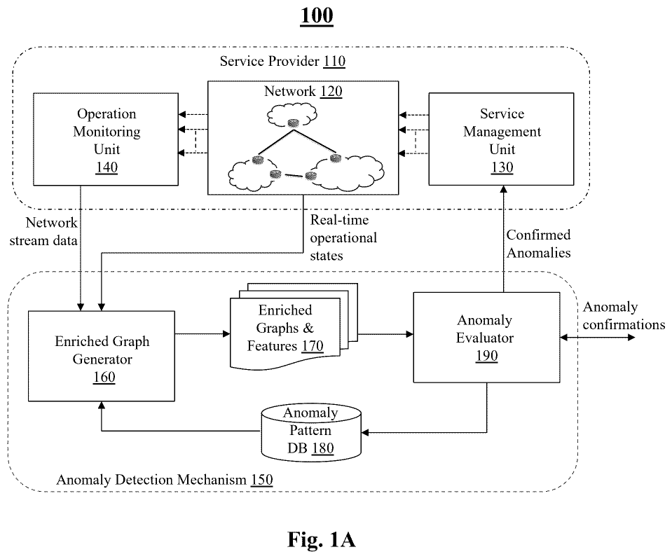

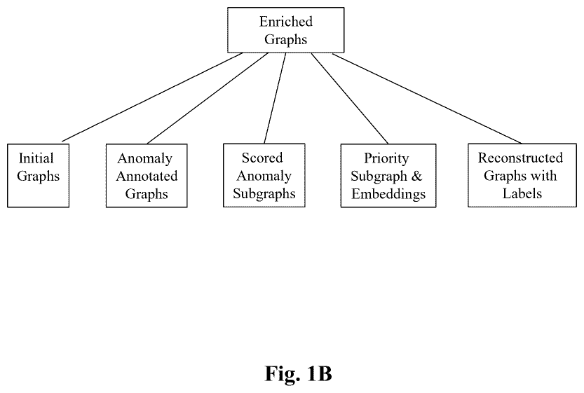

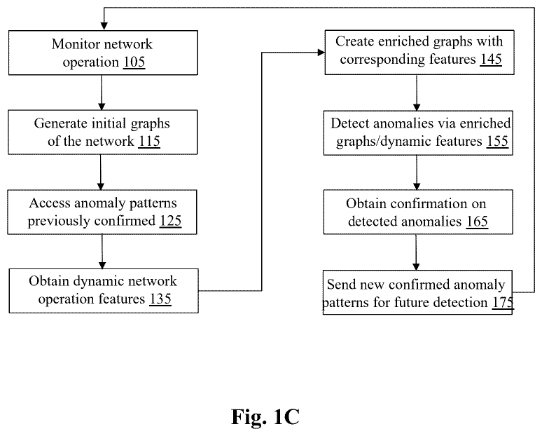

FIG. 1A depicts an exemplary framework 100 for detecting anomalies of a network 120 based on enriched graph representation of the network, in accordance with an embodiment of the present teaching. This exemplary framework 100 includes a service provider 110 operating the network 120 to provide services to its customers and an anomaly detection mechanism 150 for detecting anomalies associated with the network 120. The service provider 110 includes a service management unit 130 and an operation monitoring unit 140. The former is provided for managing the services delivered to customers via the network 120. The latter is provided for monitoring the operations of the network 120, collecting real-time network operational data stream representing the dynamic states of the network 120. The continuously collected network stream data is transmitted to the anomaly detection mechanism 150.

The anomaly detection mechanism 150 is provided for proactively detecting, in real-time, anomalies in the network 120 based on the network stream data and includes an enriched graph generator 160, and an anomaly evaluator 190. The enriched graph generator 160 is provided for processing the real-time network stream data and creating, based on past anomaly patterns stored in database 180, enriched graph representations of the network 120 with features in 170. The enriched graph representations are associated with not only the current network operational states but also sub-graphs with characterizations therein representing suspected anomalies. The anomaly evaluator 190 is provided for evaluating enriched graph representations with associated features in 170 to identify potential anomalies and obtain confirmation on such suspected anomalies. Any confirmed anomaly may then be stored in database 180 as a newly emerged anomaly if it represents a new anomaly pattern. This allows the anomaly detection mechanism 150 to adapt, in real-time, to dynamically changing fraud activity pattern by not only recording newly emerging patterns but also preemptively mitigate recurrent patterns on immediate detection

FIG. 1B illustrates exemplary types of enriched graphs generated for facilitating network anomaly detection, in accordance with an embodiment of the present teaching. As shown, exemplary enriched graphs may include, but is not limited to, initial graphs capturing the operation of the network 120 according to network nodes connected in operations, anomaly annotated graphs with nodes and edges in each sub-graph annotated with anomaly scores indicative of the likelihood of being part of an anomaly, scored anomaly subgraphs each having a score corresponding to a ranking of likelihood of the sub-graph being an anomaly, priority subgraphs each with embeddings characterizing the structural features of the subgraph with a priority assessment of the importance of the anomaly, and reconstructed graphs each being formed via hyper-linking by reconstructing a neighborhood of the subgraph via missing links to reveal an implicit anomaly at a large scale.

The features associated with each type of enriched graphs may be obtained to capture different characteristics, including, e.g., attributes associated with nodes and edges in graphs indicative of likelihood of abnormality, topological features representing structural property of subgraphs, and embeddings of sub-graphs or hyper-connected sub-graphs specifying contextual information. Such enriched graphs and features thereof provide the basis of generating an explanation of a detected anomaly (e.g., a sub-graph or hyper-connected subgraphs) which may be used to link to actionable tasks to address the detected anomalies. The enriched graphs and features thereof may characterize the network operation in such a way that enables the anomaly evaluator 190 to recognize both explicit anomaly patterns either previously existing (e.g., stored in database 180) and implicit or more complicated anomaly patterns detected via reconstructing links across different anomalous subgraphs.

FIG. 1C is a flowchart of the exemplary framework 100 for detecting anomalies of network 120 based on enriched graph representation of the network, in accordance with an embodiment of the present teaching. As discussed herein, when the service management unit 130 delivers services to customers via the network 120, the operation monitoring unit 140 monitors, at 105, the operational statuses of the network 120 to collect network stream data. When the enriched graph generator 160 receives the network stream data, it creates enriched graphs accordingly by generating, at 115, initial graphs of the network 120, accessing, at 125, the anomaly patterns stored in database 180, obtaining, at 135, dynamic network operational features, and creating, at 145, enriched graphs as discussed herein with variety of features characterizing the same. The created enriched graphs with features are then stored in 170 and used by the anomaly evaluator 190 to detect, at 155, candidate anomalies. Based on the detected candidate anomalies, the anomaly evaluator 190 interacts with human operator(s) to obtain, at 165, acknowledgment on confirmed anomalies. In some embodiments, in the process of confirming the detected anomalies, the human operator(s) may also supplement, when needed, information to explain the causal relations of the detected anomalies. The confirmed anomalies may then be sent, e.g., with the explanation, to the service management unit 130 to provide the insight as to what actions to take to resolve. In some embodiments, for any new anomaly pattern, it is also stored, at 175, back to the anomaly pattern database 180 to enable the anomaly detection mechanism 150 to adapt to the new pattern.

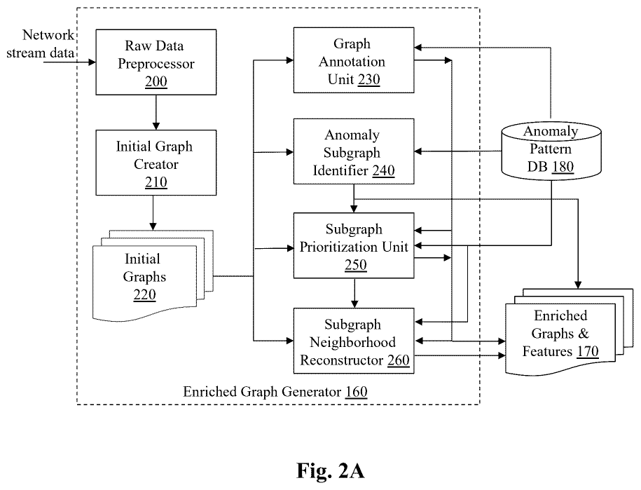

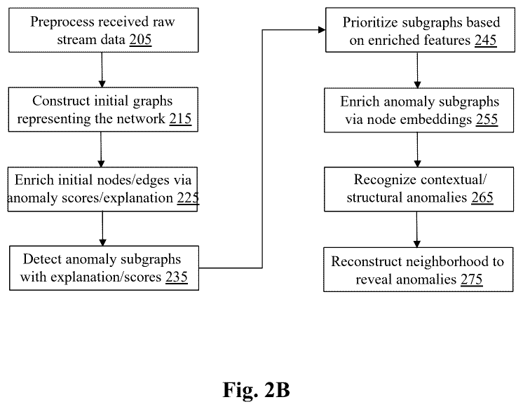

Different types of enriched graphs may be generated by different functional modules and may be stored in 170 so that the anomaly evaluator 190 may access as the base information to detect anomalies. FIG. 2A depicts an exemplary system diagram of the enriched graph generator 160, in accordance with an embodiment of the present teaching. As illustrated, the enriched graph generator 160 comprises a raw data preprocessor 200, an initial graph creator 210, a graph annotation unit 230, an anomaly subgraph identifier 240, a subgraph prioritization unit 250, and a subgraph neighborhood constructor 260. The initial graph creator 210 is provided for creating initial graphs 220 representing the network in operation based on received real-time network stream data. Each initial graph includes nodes and edges, where nodes may represent, e.g., entities such as users, sessions, or resources, etc. The edges may represent relationships or actions involving different entities, including, e.g., logins, shared IPs, resource accesses, etc. The nodes and edges in each initial graph may also have attributes. For example, a node representing a user may have attributes related to personal information of the user, e.g., name, demographics, login name, password, etc. Each edge may also have attributes, e.g., an edge representing a login action may have associated features such as date/time of the login, the number of tries of the login, etc. There may be other types of features associated with nodes or edges in initial graphs. This may include, e.g., anomaly related features such as hop encoding features (e.g., one hop context features on, e.g., unusual IP address or unusual timestamp, two hop context features on, e.g., sensitive files accessed in bulk in a single session, or session bypass without involving a validation server), relation encoding features (on anomalous edges relating to, e.g., bulk access or unusual download acts), or grouping encoding features (e.g., on different user groups such as unknown user group, legitimate user group, etc.). Such features may be obtained during preprocessing of the stream data and may be determined based on the real-time operational data states.

The initial graphs 220 are used as the basis for creating other enriched graphs, as illustrated in FIG. 2A. The graph annotation unit 230 is provided to enrich the features associated with initial graphs, including features associated with nodes, edges, or topologies of the initial graphs. The enriched features may include, e.g., node level anomaly scores, edge level anomaly scores, explanations about attention scores related to anomalies (e.g., sequence embeddings, prioritized nodes and relationships), deviation related anomalies (e.g., node embeddings, node deviations from regular node clusters), feature importance related anomalies (e.g., feature scores per node; node-based feature importance for deviation). These added features may be directed to anomalous characteristics related to nodes, edges, and observed deviations from what are known as represented by the known anomaly patterns stored in 180.

The anomaly subgraph identifier 240 may be provided to detect, from initial graphs 220, any subgraph that may exhibit some anomaly pattern, according to the previously stored anomaly patters in database 180. The processing carried out by the anomaly subgraph identifier 240 may focus on graph level to detect anomalies by examining mutual information across graph views and recognize specific subgraphs that may be responsible for known anomaly patterns. For example, if a subgraph representing an event that a user (a node in an initial graph) connects to the network 120 from a blacklisted domain (a different group node in the initial graphs 220) is detected, this subgraph may be identified as a candidate anomaly based on, e.g., previously stored anomaly patterns in 180 that indicates that a connection to the blacklisted domain is likely problematic and may constitute an anomaly. In such a detected subgraph, the nodes and edges involved in the anomaly may be further annotated with additional anomality weights. For example, the nodes representing the user and the blacklisted domain may be assigned anomality weights. So is the connection linking the two nodes to, e.g., highlight the parties implicated in the anomaly. These weights may also be used in combination to compute an anomaly score and embeddings characterizing the subgraph with an explanation why the subgraph has an unusually high anomalous score because the connection is made by a user to a blacklisted domain.

Such identified subgraphs representing candidate anomalies may be further processed by the subgraph prioritization unit 250 to prioritize the candidate anomalies to recognize which anomalies may be more critically important based on, e.g., the enriched features added to the nodes/edges by the graph annotation unit 230 as well as the knowledge that the subgraph prioritization unit 250 learned previously from, e.g., the stored anomaly patterns in database 180. In some embodiments, the subgraph prioritization unit 250 may be provided to detect malicious events from heterogeneous graphs representing account-device relationships by relying on an attention mechanism to learn node importance and aggregation features from previous aggregation patterns (e.g., “device aggregation” and “activity aggregation” patterns) and apply the learned knowledge to recognize the severity of each candidate anomaly. The processing may focus on nodes to determine the anomaly scores associated therewith in each candidate anomaly represented by a subgraph and embeddings representing the same.

Based on the initial graphs with enriched features provided by the graph annotator 230, the subgraphs detected by anomaly subgraph identifier 240 with embeddings characterizing such subgraphs, as well as the prioritized subgraphs with node embeddings from the subgraph prioritization unit 250, the subgraph neighborhood reconstructor 260 reconstructs the neighborhood of subgraphs (e.g., high priority ones) by filling missing nodes/links in the form of embeddings according to, e.g., knowledge learned from the anomaly patterns previously stored in 180. For example, historical anomaly contextual graphs, historical anomaly structural graphs, and historical joint anomaly graphs may be learned, via e.g., machine learning, from the previously stored anomaly patterns. A historical anomaly contextual graph may capture the situation where a node has unusual node attributes as compared to its neighbors or a broader graph, but its connections appear normal, signifying that although there are normal structural connections, the node has unexpected attribute values. For example, a user may usually log in from New York during working hours using a corporate laptop but, suddenly, the same user logs in from an unfamiliar location using an unrecognized browser and device. A historical anomaly structural graph may capture the situation where the attributes of a node are normal but unusual connections are made, signifying that patterns of connections deviate from the expected topology. For example, a malicious entity may gain access to a legitimate user's account and log in. The entity's activity may include, e.g., downloading a large volume of data from a location never appeared previously or interacting with devices or systems that the legitimate user never did previously. A historical joint anomaly graph may capture a combination of contextual and structural anomaly. The reconstruction of neighborhood by filling in missing nodes/links may be to reveal potentially new or a larger scale anomaly that would not be recognizable otherwise based on detected subgraphs.

FIG. 2B is a flowchart of an exemplary system diagram of the enriched graph generator 160, in accordance with an embodiment of the present teaching. Upon receiving the network stream data, the raw data preprocessor 200 preprocesses, at 205, the raw data stream and sends the processed stream data to the initial graph generator 210, which constructs, at 215, the initial graphs 220 according to the stream data representing the current states of the network 120. As discussed herein, the initial graphs 220 are used as the input to the exemplary modules 230-260 for producing different enriched graphs. The graph annotation unit 230 enriches, at 225, the nodes/edges in the initial graphs with anomaly scores as well as explanations for such enriched features, as discussed above. The anomaly subgraph identifier 240 detects, at 235 based on the initial graphs 220, subgraphs that may represent anomalies and associated features (subgraph scores and/or embeddings) with explanations in terms of both contextual and structural characteristics of the subgraphs as described herein.

The subgraphs representing candidate anomalies may then be prioritized, at 245, by the subgraph prioritization unit 250 based on the features of the nodes/edges in the subgraphs (including the enriched anomaly features added by the graph annotation unit 230) as well as the features characterizing the subgraphs (such as anomaly score and embeddings provided by the anomaly subgraph identifier 240) in accordance with, e.g., the knowledge learned from past anomaly patterns stored in database 180. Embeddings may be computed to further enrich, at 255, the nodes in the subgraphs to indicate the level of severity of underlying anomalies represented by such subgraphs. The subgraph neighborhood reconstructor 260 then utilizes the initial graphs 220 as well as enriched information at both node/edge and subgraph levels from other modules to recognize, at 265, structural and contextual anomalies from the candidate subgraphs with enriched features based on previously known anomaly patterns represented by, e.g., historical anomaly contextual graphs, historical anomaly structural graphs, and historical joint anomaly graphs. Based on the recognized types of anomalies, the subgraph neighborhood reconstructor 260 may accordingly reconstruct, at 275, neighborhoods of the subgraphs of the anomalies by, e.g., filling the missing nodes and edges as discussed herein. In some situations, the filled-in missing nodes or edges may make an anomaly more explicit. In some situations, some subgraphs initially detected as isolated candidate anomalies of relatively lower risk levels may now be connected via the filled-in missing links to form a larger subgraph that may reveal an anomaly at a larger scale and poses a higher level of risk.

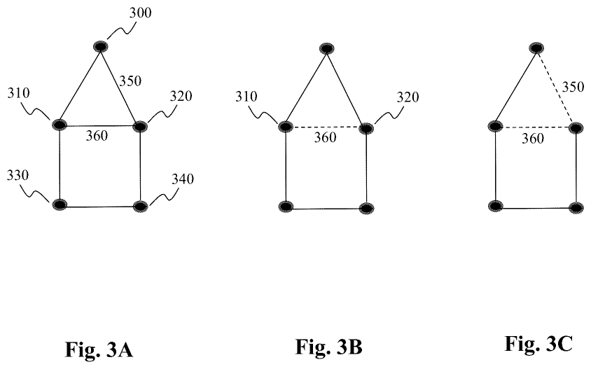

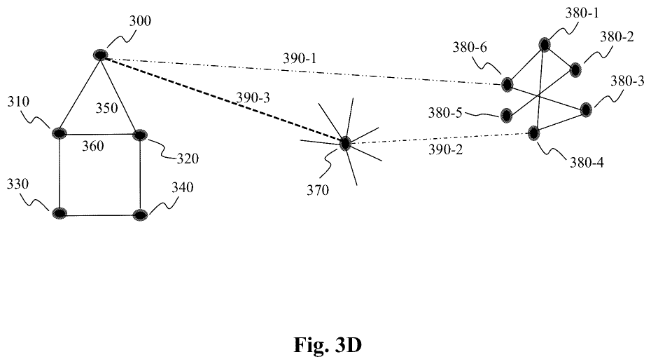

FIG. 3A-3D show exemplary illustrations on how the present teaching operates, in accordance with an embodiment of the present teaching. FIG. 3A shows an exemplary subgraph representing a normal network operation process, such as a login process. This exemplary subgraph has multiple nodes and edges, including node 300 representing an entity such as a user, node 310 representing an identifier such as a user login name presented in the login process, node 320 representing authentication information such as a password, node 330 representing a valid group of users, and node 340 representing a group of valid authentication information. The edges in this example may represent some actions carried out in the login process. For instance, the edge between 300 and 310 may represent an action that a user (300) provided a user login name (310) to the system. The edge 350 between 300 and 320 may represent an action that the user 300 provided some authentication information (320) to the system. The edge 360 between 310 and 320 may represent an action of authenticating a given user by checking on the given login name (310) against a valid group of users (330) to see if the given login name is one of them and checking against the known group of valid authentication information to see if the authentication information provided by the user (320 such as a password) is a match.

FIG. 3B shows a subgraph from the initial graphs 220. As seen, the subgraph in FIG. 3B has a similar structure as that in FIG. 3A. However, the edge 360 (as appearing in FIG. 3A) is missing in FIG. 3B, which may represent a security breach as this indicates that the check on the validity of the user and the authentication information was not carried out. In this case, the graph annotation unit 230 may add anomaly scores to nodes 310 and 320. In some implementations, the non-existing edge between 310 and 320 may also be annotated as missing with some anomaly score added thereto. Such enriched features may provide useful information in subsequent processing. The subgraph in FIG. 3B may be detected by the anomaly subgraph identifier 240 as a candidate anomaly due to its topological similarity to the subgraph in FIG. 3A. FIG. 3C shows yet another even more serious security breach because both edges 350 and 360 are missing, i.e., not only no authentication information was provided but also the check on validity of the user login name as well as the authentication information was not carried out.

FIG. 3D shows an example of reconstructing neighborhoods of isolated anomalies to reveal an anomaly at a larger scale, in accordance with an embodiment of the present teaching. In this example, there are several isolated subgraphs. The first one in FIG. 3D is the subgraph on the left (with the same structure as one shown in FIG. 3A) representing a network login process which seems to be carried out without abnormalities. The second subgraph is one in the middle representing a candidate anomaly pattern where a single entity represented by node 370 corresponding to the entity 300 accessed some never-previously-accessed file sites and downloaded a large sum of files from all of them. The third subgraph is the one on the right representing multiple malicious entities detected in the past (represented respectively by nodes 380-1 to 380-6), who have gained accesses as legitimate users and performed some malicious acts, including downloading secure files from previously-never-accessed locations in a short time. Leveraging historical structural anomaly patterns, these isolated subgraphs may be connected to form a larger subgraph to reveal a higher security risk more explicitly. For instance, new edges may be filled in to connect nodes in different subgraphs such as edge 390-1 connecting node 300 with in the first subgraph and node 380-6 in the third subgraph because, e.g., both had accessed secure file sites from previously-never-accessed locations. Also edge 390-2 may be reconstructed between node 380-4 and node 370 because, e.g., they both acted in the similar usual way to download a large number of files in a very short time period. Due to the added edges 390-1 and 390-2, another edge 390-3 may be filled in between node 300 and 370 as both have interacted using devices that the legitimate users they claimed to be had never used previously. These added edges may reveal a larger security threat as it seemed to suggest that multiple entities in the organization represented by the third subgraph may correspond to a malicious organization as multiple members thereof had performed some suspicious tasks, in a suspicious manner (pretending to be some legitimate users yet using devices that the legitimate users never used to access file sites that the legitimate users never previously accessed). Such reconstructed larger subgraphs may then be stored together with the individual subgraphs included therein.

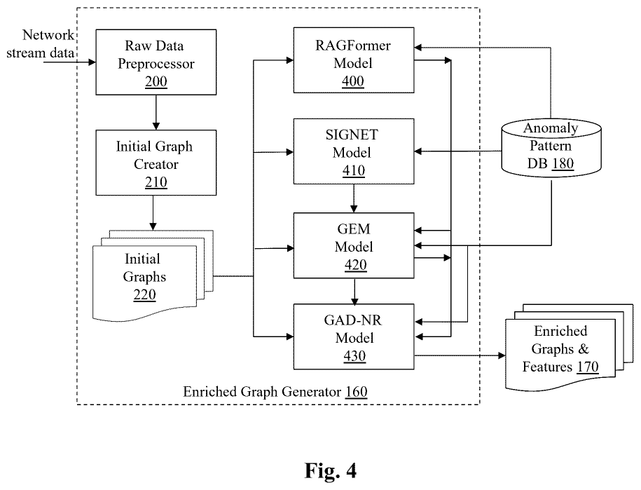

In some embodiments, each of the modules 230-260 may be implemented based on graph neural networks (GNNs) directed to processing graph related data, capable of recognizing structural and contextual patterns and characterization thereof in terms of different features (node level, edge level, and graph level) based on knowledge obtained based on training data via machine learning. FIG. 4 shows an exemplary implementation of the enriched graph generator 160 with modules 230-260 realized using different types of GNNs for generating different enriched graph representations, in accordance with an embodiment of the present teaching. In this illustrated embodiment, the graph annotation unit 230 may be implemented using a Relation-Aware GNN with Transformer or RAGFormer model 400, which is provided to integrate both semantic attributes and topological structures to annotate nodes/edges in a graph representation with enriched features relevant to fraud detection. A RAGFormer model uses a semantic encoder (Transformer) to capture semantic features across relationships and a topology encoder (that is a relation-aware GNN) for topological features, with an attention fusion module combining therein.

The anomaly subgraph identifier 240 may be implemented using a Self-Interpretable Graph Anomaly Detection Network (SIGNET) model 410, as shown in FIG. 4. A SIGNET model is generally provided for focusing on graph-level anomaly detection, which provides explanations for its predictions of anomaly subgraphs. Using a multi-view subgraph information bottleneck framework, the SIGNET model 410 is able to detect anomalies by examining mutual information across graph views and highlights specific subgraphs that may represent anomalies. In addition, the subgraph prioritization unit 250 may be implemented using a Graph Embeddings for Malicious Accounts model or GEM model 420, which may be realized for detecting malicious accounts in heterogeneous account-device graphs by leveraging the “device aggregation” and “activity aggregation” patterns of attackers and using attention mechanisms to learn node importance and aggregate features for anomaly detection.

Furthermore, the subgraph neighborhood reconstructor 260 may be implemented using a GNN on Graph Anomaly Detection via Neighborhood Reconstruction or a GAD-NR model 430, which aims to detect anomalies in graphs by reconstructing the local neighborhood of nodes, as discussed herein by handling structural, contextual, and joint structural/contextual type anomalies by focusing on the attributes and connections of nodes and their neighbors. The exemplary GNNs utilized for implementing modules 230-260 as illustrated in FIG. 4 are provided merely for illustration rather than as limitations. Any other implementation may be used to generate enriched graph representations of the network 120 with features at different levels of detail to reveal relevant symptomatic characteristics associated with any anomaly.

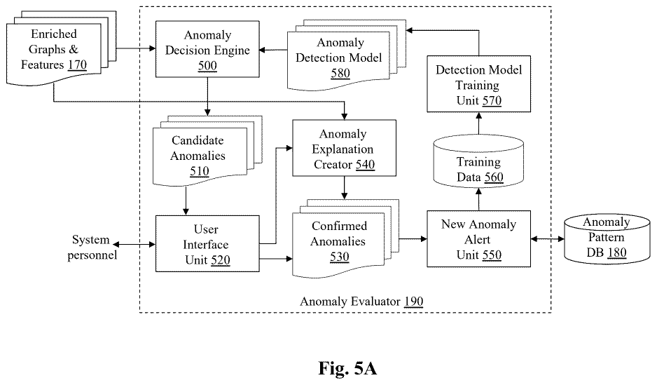

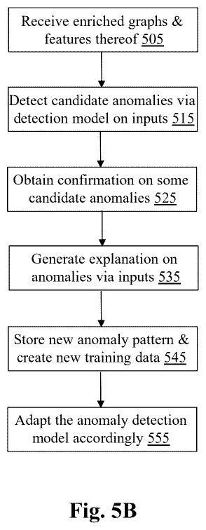

As discussed herein, the enriched graphs and features in 170 as obtained by the enriched graph generator 160 are then used by the anomaly evaluator 190 to detect anomalies. FIG. 5A depicts an exemplary system diagram of the anomaly evaluator 190, in accordance with an embodiment of the present teaching. In this illustrated embodiment, anomaly evaluator 190 includes two parts. The first part is for recognizing network anomalies, using a detection model, based on enriched graphs and features thereof generated according to the present teaching. The second part is for obtaining the detection model using machine learning based on training data having confirmed anomalies represented in graph forms with various features thereof. The detection model is continually updated based on newly detected anomaly patterns so that the anomaly detection using the detection model is adapted to the dynamics of the network operation.

The first part of the anomaly evaluator 190 comprises an anomaly decision engine 500, a user interface unit 520, an anomaly explanation generator 540, and a new anomaly alert unit 550. The second part includes the new anomaly alert unit 550 and a detection model training unit 570. FIG. 5B is a flowchart of an exemplary process of the anomaly evaluator 190, in accordance with an embodiment of the present teaching. In operation, when the anomaly evaluator 190 receives, at 505, the enriched graphs and associated features 170, it detects, at 515, candidate anomalies 510 in accordance with a trained anomaly detection model 580. Such detected candidate anomalies may be presented to a management personnel via the user interface unit 520 to seek confirmation of the detection results. When the confirmations are obtained, at 525, the anomaly explanation generator 540 creates, at 535, explanations for the confirmed anomalies 530. The new anomaly alert unit 550 then check whether there are any new anomalies in the confirmed anomalies 530 as compared with previously detected anomaly patterns in database 180. If so, the new anomaly alert unit 550 stores, at 545, the newly confirmed anomaly patterns in database 180 so that the new anomaly pattern may be used for identifying subgraphs that may represent the new anomaly pattern. The new anomaly pattern(s) may also be used to update the training data stored in 560 so that the detection model training unit 570 may subsequently adapt, at 555, the anomaly detection model 580 via machine learning based on the updated training data in 560.

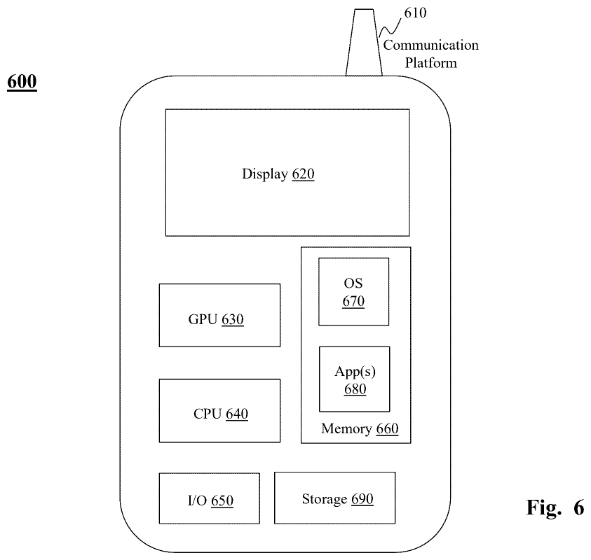

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

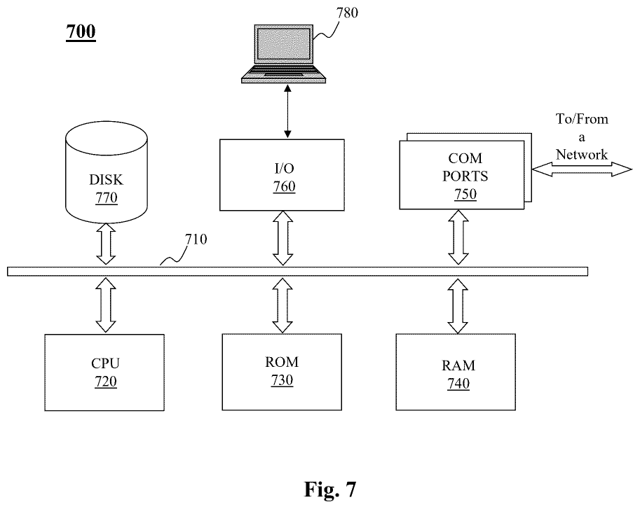

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
collecting network stream data from a network in operation;
constructing initial graphs representing the operation of the network based on the network stream data, wherein the initial graphs comprise attributes associated with each node and each edge therein, wherein a node represents an entity in the network and each edge represent a network relation between two network entities;
generating enriched graphs and associated features based on the initial graphs and previously detected anomaly patterns by:
adding enriched features to the nodes and edges of the initial graphs, wherein the enriched features include anomaly scores and explanations thereof,
identifying subgraphs from the initial graphs and based on the previously detected anomaly patterns, wherein each of the subgraphs represents a candidate anomaly characterized based on graph level features with corresponding explanations thereof,
prioritizing the subgraphs based on the enriched features associated with nodes/edges therein as well as the characterizing graph level features with corresponding explanations,
reconstructing, with respect to each of some of the subgraphs representing a candidate anomaly, a neighborhood thereof to create an expanded subgraph by linking the subgraph with other of the subgraphs via missing edges recognized from known contextual and structural anomaly patterns in the previously detected anomaly patterns; and
detecting, via an anomaly detection model, network anomalies based on the enriched graphs and features thereof.

2. The method of claim 1, wherein the enriched graphs and the associated features are generated using graph neural networks (GNNs).

3. The method of claim 1, wherein each of the nodes represents an entity which includes:
a user;
an IP address;
a login name;
authentication information; and
a network component.

4. The method of claim 1, wherein each of the edges connects two nodes represents respective entities representing:
a relation between the two entities;
an operation performed by one of the two entities in connection with the other of the two entities; and
an information channel between the two entities.

5. The method of claim 1, wherein the detecting the network anomalies comprises:
receiving the enriched graphs and the associated features;
detecting candidate network anomalies based on the enriched graphs and the associated features in accordance with the anomaly detection model; and
with respect to each of the candidate network anomalies,
seeking a confirmation for the candidate network anomaly,
upon receiving the confirmation,
creating an explanation of the candidate network anomaly based on the associated features of the enriched graphs and the previously detected anomaly patterns, and
outputting the confirmed candidate network anomaly as a detected network anomaly.

6. The method of claim 5, further comprising:
with respect to each of the detected network anomalies,
determining whether the detected network anomaly represents a new anomaly pattern with respect to the previously detected anomaly patterns, and
if the detected network anomaly represents a new anomaly pattern, storing the detected network anomaly with the previously detected anomaly patterns to generate updated previously detected anomaly patterns.

7. The method of claim 5, further comprising:
updating training data for training the anomaly detection model based on each detected network anomaly; and
training, via machine learning, the anomaly detection model based on the updated training data;
creating an updated anomaly detection model based on the training result that is adaptive to the previously detected anomaly patterns.

8. A machine-readable and non-transitory medium having information recorded thereon, wherein the information, when read by the machine, causes the machine to perform the following steps:
collecting network stream data from a network in operation;
constructing initial graphs representing the operation of the network based on the network stream data, wherein the initial graphs comprise attributes associated with each node and each edge therein, wherein a node represents an entity in the network and each edge represent a network relation between two network entities;
generating enriched graphs and associated features based on the initial graphs and previously detected anomaly patterns by:
adding enriched features to the nodes and edges of the initial graphs, wherein the enriched features include anomaly scores and explanations thereof,
identifying subgraphs from the initial graphs and based on the previously detected anomaly patterns, wherein each of the subgraphs represents a candidate anomaly characterized based on graph level features with corresponding explanations thereof,
prioritizing the subgraphs based on the enriched features associated with nodes/edges therein as well as the characterizing graph level features with corresponding explanations,
reconstructing, with respect to each of some of the subgraphs representing a candidate anomaly, a neighborhood thereof to create an expanded subgraph by linking the subgraph with other of the subgraphs via missing edges recognized from known contextual and structural anomaly patterns in the previously detected anomaly patterns; and
detecting, via an anomaly detection model, network anomalies based on the enriched graphs and features thereof.

9. The medium of claim 8, wherein the enriched graphs and the associated features are generated using graph neural networks (GNNs).

10. The medium of claim 8, wherein each of the nodes represents an entity which includes:
a user;
an IP address;
a login name;
authentication information; and
a network component.

11. The medium of claim 8, wherein each of the edges connects two nodes represents respective entities representing:
a relation between the two entities;
an operation performed by one of the two entities in connection with the other of the two entities; and
an information channel between the two entities.

12. The medium of claim 8, wherein the detecting the network anomalies comprises:
receiving the enriched graphs and the associated features;
detecting candidate network anomalies based on the enriched graphs and the associated features in accordance with the anomaly detection model; and
with respect to each of the candidate network anomalies,
seeking a confirmation for the candidate network anomaly,
upon receiving the confirmation,
creating an explanation of the candidate network anomaly based on the associated features of the enriched graphs and the previously detected anomaly patterns, and
outputting the confirmed candidate network anomaly as a detected network anomaly.

13. The medium of claim 12, wherein the information, when read by the machine, further causes the machine to perform:
with respect to each of the detected network anomalies,
determining whether the detected network anomaly represents a new anomaly pattern with respect to the previously detected anomaly patterns, and
if the detected network anomaly represents a new anomaly pattern, storing the detected network anomaly with the previously detected anomaly patterns to generate updated previously detected anomaly patterns.

14. The medium of claim 12, wherein the information, when read by the machine, further causes the machine to perform:
updating training data for training the anomaly detection model based on each detected network anomaly; and
training, via machine learning, the anomaly detection model based on the updated training data;
creating an updated anomaly detection model based on the training result that is adaptive to the previously detected anomaly patterns.

15. A system, comprising:
an operation monitoring unit implemented by a processor and configured for collecting network stream data from a network in operation;
an enriched graph generator implemented by a processor and configured for
constructing initial graphs representing the operation of the network based on the network stream data, wherein the initial graphs comprise attributes associated with each node and each edge therein, wherein a node represents an entity in the network and each edge represent a network relation between two network entities,
generating enriched graphs and associated features based on the initial graphs and previously detected anomaly patterns by:
adding enriched features to the nodes and edges of the initial graphs, wherein the enriched features include anomaly scores and explanations thereof,
identifying subgraphs from the initial graphs and based on the previously detected anomaly patterns, wherein each of the subgraphs represents a candidate anomaly characterized based on graph level features with corresponding explanations thereof,
prioritizing the subgraphs based on the enriched features associated with nodes/edges therein as well as the characterizing graph level features with corresponding explanations,
reconstructing, with respect to each of some of the subgraphs representing a candidate anomaly, a neighborhood thereof to create an expanded subgraph by linking the subgraph with other of the subgraphs via missing edges recognized from known contextual and structural anomaly patterns in the previously detected anomaly patterns; and
an anomaly evaluator implemented by a processor and configured for detecting, via an anomaly detection model, network anomalies based on the enriched graphs and features thereof.

16. The system of claim 15, wherein the enriched graphs and the associated features are generated using graph neural networks (GNNs).

17. The system of claim 15, wherein
each of the nodes represents an entity which includes:
a user,
an IP address,
a login name,
authentication information, and
a network component; and
each of the edges connects two nodes represents respective entities representing:
a relation between the two entities,
an operation performed by one of the two entities in connection with the other of the two entities, and
an information channel between the two entities.

18. The system of claim 15, wherein the detecting the network anomalies comprises:
receiving the enriched graphs and the associated features;
detecting candidate network anomalies based on the enriched graphs and the associated features in accordance with the anomaly detection model; and
with respect to each of the candidate network anomalies,
seeking a confirmation for the candidate network anomaly,
upon receiving the confirmation,
creating an explanation of the candidate network anomaly based on the associated features of the enriched graphs and the previously detected anomaly patterns, and
outputting the confirmed candidate network anomaly as a detected network anomaly.

19. The system of claim 18, wherein the detecting the network anomalies further comprises:
with respect to each of the detected network anomalies,
determining whether the detected network anomaly represents a new anomaly pattern with respect to the previously detected anomaly patterns, and
if the detected network anomaly represents a new anomaly pattern, storing the detected network anomaly with the previously detected anomaly patterns to generate updated previously detected anomaly patterns.

20. The system of claim 18, wherein the detecting the network anomalies further comprising:
updating training data for training the anomaly detection model based on each detected network anomaly; and
training, via machine learning, the anomaly detection model based on the updated training data;
creating an updated anomaly detection model based on the training result that is adaptive to the previously detected anomaly patterns.
